(19) United States
(12) Patent Application Publication
(10) Pub. No.: US 2024/0349647 A1
(43) Pub. Date: Oct. 24, 2024

(54) HARVESTING APPARATUS

(71) Applicant: Josef COOK, Wesley Vale (AU)

(72) Inventor: Michael MUNRO, Spreyton (AU)

(21) Appl. No.: 18/686,183

(22) PCT Filed: Aug. 25, 2022
(86) PCT No.: PCT/AU2022/051042

§ 371 Date: Feb. 23, 2024

(30) Foreign Application Priority Data
Aug. 25, 2021 (AU) 2021221852

(51) Int. Cl. A01D 45/26

(52) U.S. Cl. CPC A01D 45/266

(57) ABSTRACT

The invention concerns a cutting and/or carrying unit for a harvester, the cutting and/or carrying unit having: a series of cutting and/or carrying segments, each segment in the series being adapted to cause cutting of a crop and/or carrying of the crop; a cutting and/or carrying unit circuit around which the series of segments travel; and a driving mechanism to drive movement of the series of segments around the circuit; wherein the driving mechanism drives movement of the series of cutting and/or carrying segments around the circuit to cut the crop and/or to carry harvested crop, as the series of segments travels around the circuit. The invention also concerns harvesters incorporating said cutting and/or carrying units.

### FIELD OF THE INVENTION

The present invention relates to harvesting apparatus, and more particularly the invention relates to harvesting apparatus for harvesting row crops. In particularly preferred forms, the invention relates to a harvester and a cutting unit for a harvester.

The invention has been developed primarily for use in, and/or with, the harvesting of brassicas (e.g. broccoli, cabbage, cauliflower), however it will be appreciated that the invention may be applied in the harvesting of other crops having an upper harvestable portion, those that require topping (e.g. Brussels sprouts) or seed crops (e.g. onion seed, where some, but not all rows, need to be topped).

### BACKGROUND OF THE INVENTION

Harvesting is one of the largest expenses in the production process of row crops. Many row crops, in particular brassicas such as broccoli and cauliflower, are predominantly hand harvested by workers.

Conveyor, sorting and/or boxing machinery may be used together with hand harvesting workers to increase labour efficiency, in some cases by multiples of 2 or 3. However, even where hand harvested row crops are assisted by mechanical aids, there are many factors that make reliance on hand harvesting increasingly less viable.

Hand harvesting workers assess the dimensions of the crop, and selectively harvest according to the requirements of the buyer. For example, in relation to broccoli, head diameter and/or stem length need to be assessed, and heads that are malformed or past maturity may need to be skipped.

Hand harvesters usually operate in teams, and the work is generally labour intensive due to limited harvesting windows. Hand harvesters also need to be willing to work in fields that are generally wet and often in cold conditions.

Due to difficult environmental conditions, or other conditions governing the sourcing of labour such as where movement of workers from far away locations to the field is restricted, suitable personnel can therefore be difficult to find. This can substantially drive up the cost of labour and substantially add to the harvesting costs.

Hand harvesting of many crops, such as broccoli, is traditionally done via selective harvesting over multiple passes to achieve viable yields. However, advancements in hybrid varieties and improved growing practices, means that there is more uniformity of the row crop and so high yields may be achieved with a single pass (i.e. destructive) harvest. Hand harvesting makes less sense when a single pass harvest is possible because the extra costs of multiple passes is not always realised with an increased yield or return. This is particularly the case for broccoli harvested for floretting, because the market specification on size is a lot wider (by comparison, broccoli heads can have relatively narrower market specifications).

Attempts have been made at mechanising row crop harvesting in the past using various techniques.

In more recent times, mechanical brassica harvesters have been conceived. Many of these involve clamping or gripping the brassica heads or stem, and moving the brassica against a static or rotary cutter for cutting the stem, then conveying the brassica and elevating it for secondary trimming, leaf removal and grading etc. Such harvesters generally do not, or do not accurately, adjust to the height of the brassica to be harvested, to enable the brassica to be cut at a ‘sweet spot’ of the stem between the base (which is woody and more difficult to cut) and the head. Likewise, as the cutting height is not well controlled, more leaf than necessary is harvested with the brassica, which means that additional automated and/or manual trimming of the excess leaf is required, subject to the demands of the buyer. Such harvesters are generally run at a lower speed, so that they move through a single row of brassica at a rate of approximately one (1) kilometre per hour or less (or about one (1) brassica head every approx. two (2) seconds, depending on the proximity of each brassica crop in a row).

Further, mechanical harvesters may include numerous mechanical components to perform the cutting, lifting and/or carrying of the harvested brassica. These harvesters may also be cumbersome and not easily arranged to harvest a variety of row configurations.

Other mechanical brassica harvesters that have been proposed include a moveable cutting frame or container that is responsive to an electronically sensed location for individual brassica heads or stems to cut, so that a cutting frame or container approaches the head from above, one head at a time, to isolate and cut the brassicas. Such mechanical brassicas harvesters are very slow moving. For example, they may harvest only approximately 1 head every 2 seconds. Some mechanical brassica harvesters have also required de-leafing operations to be conducted prior to operation to allow the harvester to work, resulting in additional time/cost considerations.

Many of the same issues discussed above concerning the harvesting of broccoli apply to harvesting of other brassica or row crops. For example, cauliflower or cabbage.

Therefore, there is a need for an improved harvester and/or cutting unit of a harvester of row crops to obtain one or more of the following:
a. Minimised or reduced or labour costs; and/or
b. Improved control of the cutting height during mechanised harvesting; and/or
c. Reduced or minimised likelihood of mechanical breakdown or the need for servicing;
d. Improved design to allow for modular arrangements that can cut different row configurations; and/or
e. A faster cutting and harvesting rate.

It is to be understood that, if any prior art information is referred to herein, such reference does not constitute an admission that the information forms part of the common general knowledge in the art, in Australia or any other country.

### SUMMARY OF THE INVENTION

According to a first aspect of the invention there is provided a cutting unit for a harvester, the cutting unit having: a series of cutting and/or carrying segments, each cutting and/or carrying segment in the series being adapted to cause cutting of and/or carrying of the crop; and a cutting unit circuit around which the series of segments travel.

Preferably, the cutting unit includes a driving mechanism to drive movement of the series of segments around the cutting unit circuit.

Preferably, the driving mechanism drives movement of the series of cutting and/or carrying segments around the cutting unit circuit to cut and/or carry the crop, as the series of segments travels around the cutting unit circuit.

Preferably, after cutting, carrying and/or lifting the crop, the segments are adapted to release the harvested crop as the segments travel around the cutting unit circuit.

According to a second aspect of the invention there is provided a cutting unit for a harvester, the cutting unit having: a plurality of cutting and/or carrying segments, each cutting and/or carrying segment adapted to cause cutting and/or carrying of a crop; a cutting unit circuit around which the plurality of cutting segments travel; and a driving mechanism to drive movement of the segments around the cutting unit circuit; wherein the driving mechanism drives movement of the cutting and/or carrying segments around the cutting unit circuit to cut and/or carry the crop, and to release harvested crop, as the plurality of segments travel around the cutting unit circuit.

Preferably, the plurality of cutting segments comprises a series of segments.

According to a third aspect of the invention there is provided a harvester including a cutting unit according to any of the other aspects of the invention, the harvester further including a conveyor for conveying the harvested crop away from the cutting unit, the cutting unit being configured to release harvested crop to the conveyor for grading, sorting or further processing.

Preferably the series or plurality of segments comprises between about 10 and about 50 segments. In a particularly preferred form, the series or plurality of segments comprises between about 20 and about 30 segments.

Preferably, the series of cutting and/or carrying segments comprises a continuous chain, or concatenation, of adjacent segments.

Preferably, the segments are adapted to lift the harvested crop. Preferably, the segments are adapted to lift harvested crop around a part of the cutting unit circuit as the series of segments travels continuously in one direction around the cutting unit circuit.

Preferably, the cutting unit is adapted such that the segments travel continuously around the cutting unit circuit during harvesting.

Preferably, the cutting unit is adapted such that the series of segments travel in one direction around the cutting unit circuit.

Preferably, the driving mechanism drives the series of segments continuously and in one direction around the circuit.

Adjacent segments comprising the cutting segments are preferably configured to provide substantially continuous cutting of the row crop.

Adjacent segments are preferably configured to provide substantially continuous carrying, lifting and/or releasing of harvested crop.

Preferably, each segment includes one or more arms. It is preferred that the one or more arms of each segment is adapted to carry and/or lift the harvested crop.

Each cutting segment may include one or more cutters, each cutter comprising at least one cutting edge for cutting the crop. The one or more cutters are preferably adapted to carry, lift and/or release the harvested crop.

The arms may be configured such that one or more of the arms includes a portion comprising a cutter. Preferably, the cutter is located in a lower portion of the arm.

Preferably, each segment, and most preferably each cutter and/or arm, includes a paddle portion for carrying and/or lifting the harvested crop. Preferably, the paddle portion is made of a resilient material. The paddle portion may be fixed to a plate that is connected to the segment. Alternatively, the paddle portion may be integral to the segment, for example integral to an arm of the segment.

In a preferred form, each arm and/or cutter includes at least one cutting edge for cutting the row crop.

Preferably, each segment includes at least two arms, or at least two cutters, which co-operate to cut and/or carry and/or lift the crop.

At least two of the arms and/or cutters are preferably configured to oppose each other.

The cutting unit may be adapted to cause relative opening and closing of the at least two arms and/or cutters as the segment travels around the cutting unit circuit. The driving mechanism is preferably configured to cause the relative opening and closing of the at least two arms and/or cutters.

Alternatively, each cutting segment may comprise a single arm and/or cutter, with a blunt edge, adapted to push the crop towards a cutting edge

Preferably, when located in a cutting zone of the cutting unit circuit comprising a lower part of the cutting unit circuit, the cutting segments move to cut the crop. In a preferred form, the at least two arms and/or cutters move together to cut the crop. Preferably, when located in a releasing zone of the cutting unit circuit comprising an upper part of the cutting unit circuit, the at least two arms and/or cutters move away from each other to release the crop from the segments.

In a preferred form, the at least two arms and/or cutters move apart to release the crop.

The cutting unit is preferably adapted to drive the series of segments at a consistent or substantially constant speed around the cutting unit circuit during harvesting.

Preferably, during harvesting, the driving mechanism drives the segments around the circuit at a speed that is substantially the same as the speed of the harvester relative to the row crop (e.g. the same speed as the harvester land wheel, assuming good traction between the land wheel and the ground).

Preferably, during harvesting, the driving mechanism drives the segments through the cutting zone at a speed that substantially matches the speed of the harvester relative to the row crop.

Preferably, the matching of segment speed around the circuit to harvester speed provides a passive engagement (e.g. cutting and/or carrying engagement) of the segments such that the segments travel together with the crop within the cutting zone.

Preferably, harvester speed is determined by GPS input, based on RTK coordinates. Alternatively, it may be determined by an encoder that picks up revolutions of the wheel, or other means known to the skilled addressee.

Preferably, the harvester is adapted to harvest while travelling at speed in a range of between about 1 to about 10 kilometres per hour. In a preferred form, the harvester is adapted to harvest while travelling at a speed in a range of between about 2 to about 5 kilometres per hour. In a particularly preferred form, the harvester is adapted to harvest while travelling at a speed in a range of between about 3 and about 4 kilometres per hour.

Preferably, adjacent segments are configured to provide substantially continuous cutting and/or carrying in a zone including a low point of the cutting unit circuit.

Preferably, the cutting unit circuit is circular, or substantially circular. Alternatively, the cutting unit circuit may be elliptical or oval.

Preferably, the cutting unit includes a cutting unit roller, the segments being connected thereto. Preferably, the roller is configured in a drum like form. It is preferred that the cutting unit roller operates as, or as part of the driving mechanism. Preferably, the segments are adapted to pivot relative to the cutting unit roller as the roller rolls. The segments may be pivotally connected to the cutting unit roller.

It is preferred that rolling of the cutting unit roller causes movement (e.g. pivotal movement) by the segments as they interact with the guide means. The means may include mechanical and/or electrical componentry, including a physical guide, or a guiding force field (e.g. an electromagnetic guide).

The driving mechanism preferably includes a guide means to guide movement of the segments (for example, to drive relative movement of the two arms and/or cutters) as they travel around the cutting unit circuit to cut and release the crop.

In a preferred form, the guide means comprises a track that mechanically interacts with the segments. Preferably, the segments include wheels that travel around the track. Preferably, rolling of the cutting unit roller drives movement of the cutting segments (for example, relative movement of two or more arms and/or cutters) as the segments travel around the cutting unit circuit.

Preferably, the driving mechanism is adapted to cause relative movement of the cutting segments, and in particular opening and closing of the cutters and/or arms. For example, rotating the cutting unit roller to which cutters and/or arms are pivotally attached, may cause the cutters and/or arms to close when they reach the cutting zone. Preferably, closing of the cutters and/or arms may be facilitated by use of springs that bias the cutters and/or arms to the closed position.

In a particularly preferred form, the cutters and/or arms of the cutting segments are moved between a cutting and non-cutting position by a primary (or first) cutting control mechanism as well as a secondary (or second or back-up) cutting control mechanism. In a particularly preferred example, the primary cutting control mechanism includes a spring or means (e.g. another potential energy storing means) to enable a fast cutting movement of the cutters and/or arms of the cutting segments. Alternatively, an actuator may be used (e.g. a pneumatic actuator) to rapidly drive movement of the cutters between the open and closed positions in a cutting zone. The second cutting control mechanism may include guide means to guide each of the cutting segments around the cutting circuit and to cut completion in the cutting zone, where the fast cutting movement of the first cutting control mechanism does not complete cutting of the crop. The cut completion position, in relation to the cutters and/or arms of the cutting segments, may be understood as the position where two cutters and/or arms have moved together to contact one another (e.g. a cutting edge of each of two cutters and/or arms in a cutting segment are touching).

The guide means is preferably configured to be used together with the spring or other primary cutting control mechanism, such that the guide means (e.g. a track) changes in dimension (e.g. widens) and/or changes in direction (e.g. is directed at, or near to right angles from the preceding portion of the track) to enable the spring or other means to freely operate within a boundary of the guide means (e.g. within a first and second wall of the track). The guide is preferably configured to force the cutters to cut completion where the spring or other primary cutting control mechanism does not achieve cut completion.

Preferably, the roller is configured in the form of a drum and a series of first cutters and/or arms are pivotally attached to a first rim of the drum, and a series of second cutters and/or arms are pivotally attached to a second rim of the drum, where the first rim of the drum opposes the second rim of the drum. Preferably, the first rim of the drum borders, or is adjacent to, a first guide track for controlling pivoting movement of the series of first cutters and/or arms, and the second rim of the drum borders, or is adjacent to, a second guide track for controlling pivoting movement of the series of second cutters and/or arms. It is preferred that each of the first and second cutters and/or arms include a cutter/arm roller which travels within the first and second guide track, respectively.

Alternatively, the guide means may comprise electronic or pneumatic actuators, or electrically controlled zones that actuate a solenoid on the arm and/or cutter to guide its location relative to an electromagnetic track.

Preferably, rolling of the cutting unit roller drives the segments around the guide means (e.g. the track).

Preferably, the driving mechanism includes a belt that travels around at least a part of the cutting unit circuit. Preferably, the the belt, or part of the belt, forms the harvester conveyor. Alternatively, the harvester may include a conveyor that does not travel around the cutting unit circuit. Such a conveyer is preferably positioned to receive harvested crop that is released by the cutting unit.

The term ‘around’, in the context of the belt travelling around the cutting unit circuit, does not require the belt to travel along the exact same path as the segments, but rather along a path near to or adjacent the path travelled by the segments as they travel around cutting unit circuit. In particular, there is preferably a space between the belt and the segments to enable the carrying and lifting of the harvested crop therebetween. Preferably, the belt and segments co-operate to carry and lift the harvested crop as the segments and belt travel around the cutting circuit.

A first side of the belt may face the crop during cutting, and then receive and convey the crop as it is released from the segments. A second side of the belt may face the roller when the belt is travelling around the cutting unit circuit.

Preferably, the belt forms a loop that at one end travels around the cutting unit roller.

Preferably, the belt travels around a driving roller and the cutting unit roller to cause rolling of the cutting unit roller.

Preferably, the belt couples or links with the cutting unit roller of the harvester.

The belt may frictionally engage with the cutting unit roller of the harvester.

The belt preferably includes one or more chain loops that couple with the driving roller and cutting unit roller.

Preferably, the belt is configured to travel around a loop including at least a part of the cutting unit circuit, the loop further including one or more further harvesting sections. The one or more further harvesting sections preferably includes a grading section.

Preferably, the cutting unit roller and/or the driving roller each comprise a sprocket adapted to linkingly engage with the belt.

Preferably, the belt includes a plurality of adjacent elongate slats. Preferably, the plurality of elongate slats comprises a series of slats. Preferably, the series of slats comprises a continuous chain, or concatenation, of adjacent slats. Preferably, the elongate slats are formed, at least in part, of a flexible material. The elongate slats may be attached to the belt by take-off plates. The elongate slats are preferably spaced apart. However, the elongate slats may overlap when the slat is located along some parts of the belt loop (e.g. they may be spaced apart at points where belt is travelling around a driving roller/sprocket or cutting unit roller/sprocket, but otherwise and along different parts of the belt loop they may overlap).

Preferably, the elongate slats (or belt) travel(s) continuously in one direction. Preferably the elongate slats (or belt) travel(s) at a speed that enables them (or it) to move together or in synchronicity with segments, to assist in the carrying and lifting of the harvested crop around a part of the cutting unit circuit.

The belt may include flexible outer portions. Preferably, the flexible outer portions are adapted to flex outwardly when the segment is in a releasing configuration, and flex inwardly when the segment is in a cutting configuration. For example, the flexible outer portions are adapted to flex outwardly when the two arms or cutters are in a releasing configuration, and flex inwardly when the two arms or cutters are in a cutting configuration.

Preferably, along the conveying and grading sections of the belt, the flexible portions are held to be inwardly flexing by conveyor siding.

The belt may include two spaced apart chain loops configured to engage with corresponding spaced apart teeth wheels (e.g. sprockets) on each of the cutting unit roller and the driving roller. Alternatively, the belt may not engage with the driving roller, and just travel around the cutting unit.

The harvester preferably includes a plurality of cutting units. In a preferred form, each cutting unit includes a belt travelling around a respective cutting unit roller for each cutting unit, and each belt is able to be driven by one or more driving rollers that are driven along a common drive mechanism (for example, a common drive shaft).

The harvester may include an idler sprocket providing flat surface of the belt for grading harvested row crop.

The driving mechanism may include one or more direct driving devices to drive each of the segments to and between a cutting position and/or non-cutting position in the cutting zone and/or a carrying position (which may also provide lifting), and/or a releasing position.

For example, the mechanism may include a roller to which segments are attached, wherein as the roller rolls, the direct driving devices cause the cutting/releasing action of the segments.

Preferably, the one or more direct driving devices drive movement of the cutting and/or carrying segments to and between the cutting and/or non-cutting position and/or carrying position and/or a releasing position, in a predetermined manner depending on the location of the cutting and/or carrying segment around the cutting circuit.

In a preferred form, the segment is driven to the cutting, carrying, lifting or releasing position in a sequence that depends on its location around the cutting unit circuit.

Preferably, each segment comprises one or more cutters.

Preferably, the cutters are connected to a rotating component of the cutting unit. In a preferred arrangement, the cutters are pivotally connected to rotating component. In a particularly preferred arrangement, the cutters are pivotally connected to a roller.

The rotating component, or roller, may be driven to rotate by a variety of means, such as directly by a motor or indirectly by a belt or chain.

The cutters of the segments may be spring loaded (e.g. the primary mechanism for controlling movement of the cutters between the cutting and non-cutting position is a spring biasing the cutters towards a closed position). The cutters are preferably held in an open position (e.g. by a guide track on an interior part of a roller) during a portion of the cutting unit circuit where they approach a cutting zone, and then they are provided freedom to move (e.g. pivotally, with respect to the roller) by operation of the spring in a cutting action towards a closed position. Preferably the spring loading of the cutters provides for a rapid cutting action.

The cutters in the closed position are preferably adapted to carry and lift the crop as the segments travel around the cutting unit circuit. The cutters preferably co-operate with a belt to perform carrying and lifting of the crop. The belt is preferably a belt configured to drive the roller to which the cutters are attached. The movement of the cutters around the cutting unit circuit may be driven by other means, such as by direct driving, as discussed elsewhere in this specification.

Preferably, the one or more direct driving devices are automatically responsive to sensed information about the row crop. Sensed information may include, for example, dimension and/or location of the crop, or other information about crop that is relevant to determine whether or not to harvest a particular crop (e.g. crop colour or other visual features).

In particularly preferred arrangements, the cutting unit is configured to automatically move the segments to a non-cutting position where sensed information indicates crop is not ready/right to harvest (for example, it is too young or malformed). The driving direct device may provide selective harvesting along the row crop (e.g. where segments are selectively moved to the cutting or non-cutting position within a row of harvestable crop).

The sensed information may be used to raise or lower the entire cutting unit (for example, via a cutting unit frame with a controllable height, as described elsewhere in the specification). The sensed information may be used to adjust the crop portion cut adjuster, as described elsewhere in this specification.

Preferably, the cutting unit includes one or more sensors providing the sensed information. The one or more sensors may comprise cameras applying machine vision technology to sense crop information.

The one or more sensors providing the sensed information may comprise a displacement sensor (for example, an optical sensor, linear proximity sensor or ultrasonic sensor). The one or more sensors providing the sensed information may comprise measurement sensor (for example, a sensor that applies a wide laser being to measure changes in the amount of light).

Preferably, the direct driving device comprises a solenoid actuator.

Preferably, passive cutting and/or carrying and/or lifting action is preserved during direct driving of the cutting and/or carrying segments.

Preferably, the direct driving device comprises at least one hydraulic or pneumatic arm functionally connected to each segment

The cutting unit roller and/or belt may be configured to ride along an upper surface of the row crop to be harvested. A crop riding roller, or preferably a plurality of rollers linked by a belt to form a crop riding conveyor, may be attached to the cutting unit roller and configured to ride along an upper surface of the row crop to be harvested.

Preferably, the cutting unit is able to ride on the row crop such that it rocks back and forward and/or moves up and down relative to a frame of the cutting unit or harvester, and/or another part of the harvester, depending on the height of the row crop.

Preferably, the cutting unit is configured to rock back and forwards and/or move up and down depending on the height of the row crop.

Preferably, the cutting unit configured to rock back and forwards includes a pivot point about which the unit rocks back and forward depending on the height of the row crop.

Preferably, the cutting unit or harvester frame, or another part of the harvester or cutting unit, is able to be raised or lowered by a frame height controller, to raise or lower the height of the cutting unit and thereby enable raising or lowering of an effective lowest cutting height of the cutting unit. The effective lowest cutting height is preferably where the unit is fully rocked back.

The frame height controller preferably includes a movable (e.g. pivotable and/or extendable) portion that is able to provide movement (e.g. pivoting and/or extension/contraction) of the frame upwardly to raise the cutting unit, and downwardly to lower the cutting unit.

The frame height controller may be manually controllable. Preferably, the manually controllable frame height controller is controllable in response to the movement (e.g. rocking back and forward and/or movement up and down) of the cutting unit that results from the cutting unit riding over the crop. For example, the manually controllable frame height controller may be controllable based on visual inspection of the cutting unit movement by a person on or near the harvester.

Preferably, the frame height controller includes a movable portion that is able to provide movement of the frame and/or part of the cutting unit upwardly to raise a rocking section of the cutting unit, and downwardly to lower a rocking section of the cutting unit.

The frame height controller may be automatically responsive to the rocking back and forward and/or movement up and down of the cutting unit that results from the cutting unit riding over the crop (e.g. by monitoring pivoting of the unit and/or extension and contraction in a movable portion, or other means responsive to changing ride height).

The frame height controller may include a sensor that senses the rocking of the cutting unit and/or its movement up and down, and causes the movable portion to raise or lower the frame.

Preferably, the cutting unit includes means to modify the riding sensitivity of the cutting unit on the row crop. The means may include mechanical and/or electrical componentry, including the application of software on a computer.

Preferably, the rocking cutting unit includes adjustable weighting, or spring loading at the front and back of the unit, or electronically controllable means to balance the rocking cutting unit. Balancing may be automatically responsive to the amount of broccoli carried by the cutting unit and/or the inclination of the terrain over which the cutting unit/harvester is travelling (e.g. going up and down hills, so as to follow the frame angle, but maintain rocking sensitivity).

The rocking cutting unit also may include a movable weight that is movable by mechanical or electrical operation to adjust sensitivity. Mechanical operation of the movable weight may include turning around a thread; electrical operation may include operation of an actuator (for example, a hydraulic actuator, or a linear actuator) to move the weight.

Preferably, the movable weight is located at an opposing end of the cutting unit to the end where the cutting zone is located. The movable weight may be located on a first side of the pivot point, and the cutting zone of the cutting unit may be located on a second opposing side of the pivot point.

Preferably, the cutting unit (and more particularly, the cutting unit roller) co-operates with a crop portion cut adjuster to adjust a proportion of the crop that is cut by the harvester.

The crop portion cut adjuster is preferably configured to ride, directly or indirectly, along the upper surface of the crop, and is able to be lowered toward the row crop and thereby adjust how much of the upper portion of the crop is cut by the harvester. The crop portion cut adjuster is therefore adjustable with reference to the ground or crop (in contrast to being adjustable with reference to the frame or harvester).

The cutting unit roller preferably includes a crop portion cut adjuster that engages with the belt, to lower the belt toward the row crop and thereby adjust the proportion of crop that is cut of the harvester (i.e. the crop portion cut adjuster alters the distance between the belt, and therefore upper surface of the row crop upon which the belt rides, and a point of cutting for each segment or another cutting component).

Preferably, the crop portion cut adjuster includes a rotating or sliding element that rotates or slides over the upper surface of the crop during crop riding. In a preferred form, the crop portion cut adjuster includes a rotating element that engages with the second side of the belt (i.e. the side facing the roller) and rotates as the belt moves relative to the rotating element (and so the rotating element is adapted to rotate at a speed similar to that of the harvester relative to the ground or crop). Preferably, the crop portion cut adjuster is located between two outer edges of the cutting unit roller.

The crop portion cut adjuster preferably includes an extendable component configured to raise and lower the rotating or sliding element with respect to the cutting zone of the segment. Preferably, the extendable component is extendable by manual, mechanical operation or electrical operation. Mechanical operation preferably includes turning around a thread; electrical operation includes by operation of an actuator (e.g. a hydraulic actuator, or a linear actuator).

Preferably, the cut crop portion cut adjuster is adjustable to cut a predetermined crop proportion (e.g. the upper 180 mm or head portion of a broccoli). The predetermined crop proportion may be set beforehand, according to the type of crop to be harvested and/or predetermined amounts or portions of the crop to be harvested (e.g. for processing/floretting broccoli, or for fresh market broccoli).

Preferably, the crop portion cut adjuster engages with the belt, to move the belt vertically lower (i.e. closer toward the cutting point) or higher (i.e. further away from the cutting point).

The harvester is preferably configured to harvest crops having an upper harvestable portion. In a preferred form, the row crop comprises brassicas. In a particularly preferred form, the row crop comprises broccoli.

According to fourth aspect of the invention there is provided a cutting unit for a harvester, the cutting unit having: a cutting component adapted to cause cutting of the crop; a frame connected to the cutting unit to hold the cutting unit above the crop; wherein the cutting unit is configured to ride on an upper surface of the row crop such that it rocks back and forward and/or moves up and down relative to the frame of the harvester depending on the height of the row crop.

Preferably, the frame is able to be raised or lowered by a frame height controller to raise or lower the height of the cutting unit and thereby enable raising or lowering of an effective lowest cutting height of the cutting unit. The rocking back and forward and/or moving up and down of the cutting unit may provide feedback to enable operation of the frame height controller.

Preferably, the cutting component comprises a waterjet cutting component.

In a preferred form, the cutting component comprises a rotary cutting component.

The cutting unit may include a cutting unit roller adapted to ride on the upper surface of the row crop. Preferably, the cutting unit roller is further adapted to provide lifting and/or carrying the harvested crop.

Preferably, the cutting unit roller is adapted to roll at a speed that is substantially the same as the speed of the harvester relative to the crop.

In a preferred form, the cutting unit roller is connected to one or more lifting and/or carrying sections that travel around a lifting and/or carrying circuit and are adapted to lift and/or carry the harvested crop.

Preferably, the lifting and/or carrying sections are driven to travel around the circuit, or at least a part of the circuit proximate to the cutting component, at a speed that is substantially the same as the speed of the harvester relative to the crop.

The cutting unit may include one or more crop riding roller(s) attached to the cutting unit roller adapted to ride on the upper surface of the row crop.

The harvester preferably includes a belt adapted to ride on the upper surface of the row crop.

According to a fifth aspect of the invention, there is provided a cutting unit configured to ride on an upper surface of the row crop such that it rocks back and forward and/or moves up and down, depending on the height of the row crop.

According to a sixth aspect of the invention, there is provided a cutting unit for a harvester, the cutting unit having: a series of cutting segments, each segment in the series being adapted to cause cutting of the crop; a cutting unit circuit around which the series of segments travel. Preferably, the cutting unit includes a driving mechanism to drive movement of the series of segments around the cutting unit circuit. The driving mechanism preferably drives movement of the series of cutting segments around the cutting unit circuit to cut the crop as the series of segments travels around the cutting unit circuit.

According to a seventh aspect of the invention, there is provided a crop carrying unit for a harvester, the carrying unit having: a series of carrying segments, each segment in the series being adapted to cause carrying and/or lifting of the crop; a carrying unit circuit around which the series of segments travel. Preferably, the carrying unit includes a driving mechanism to drive movement of the series of segments around the carrying unit circuit. It is preferred that the driving mechanism drives movement of the series of carrying segments around the carrying unit circuit to carry and/or lift the crop, and to release the crop, as the series of segments travels around the carrying unit circuit.

The features described in relation to one or more aspects of the invention are to be understood as applicable to other aspects of the invention. More generally, combinations of the features of the harvester and/or cutting unit of the invention described elsewhere in this specification, including in the claims, are to be understood as falling within the scope of the disclosure of this specification.

Other aspects of the invention are also disclosed.

Persons skilled in the art will appreciate that many variations may be made to the invention without departing from the scope of the invention, which is determined from the broadest scope and claims.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is an elevated rear perspective view of a front mountable two row configuration harvester according to a first preferred embodiment of the invention.

FIG. 2 is a side view of the harvester depicted in FIG. 1;

FIG. 3 is a rear view of the harvester depicted in FIG. 1;

FIG. 4 is a side perspective view of part of the harvester depicted in FIG. 1, including the cutting unit, cutting unit frame, belt siding, chained drive belt and driving roller, among other components;

FIG. 5 is a bottom perspective view of the part of the harvester depicted in FIG. 4;

FIG. 6 is a side view of the part of the harvester depicted in FIG. 4;

FIG. 7 is a bottom view of the part of the harvester depicted in FIG. 4;

FIG. 8 provides a cross-sectional view of a cutting unit according to a second preferred embodiment of the invention;

FIG. 9 is a perspective view of part of the cutting unit depicted in FIG. 4;

FIG. 10 is a front sectional view of part of a cutting unit of the harvester according to a third preferred embodiment of the invention;

FIG. 11 is a side view of part of the harvester according to FIG. 4, where the frame is in a neutral position;

FIG. 12 is a side view of part of the harvester according to FIG. 4, where the frame in a lowered position;

FIG. 13 is a side view of part of the harvester according to FIG. 4, where the frame is in a raised position;

FIG. 14 is a side view of part of a harvester according to a fourth preferred embodiment of the invention;

FIG. 15 is a side view of part of a harvester according to a fifth preferred embodiment of the invention;

FIG. 16 is a side view of part of a harvester according to a sixth preferred embodiment of the invention.

FIG. 17 is a perspective view of a cutting unit according to a seventh preferred embodiment of the invention;

FIG. 18 is a side view of the cutting unit depicted in FIG. 17;

FIG. 19 is a perspective view of part of the cutting unit depicted in FIG. 17, including the rear roller and cutting segments;

### DETAILED DESCRIPTION

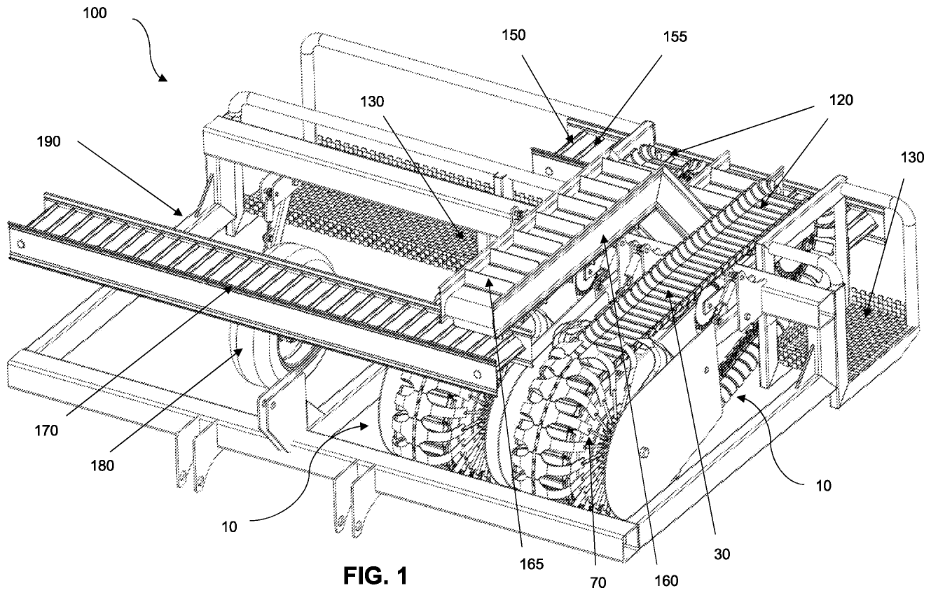

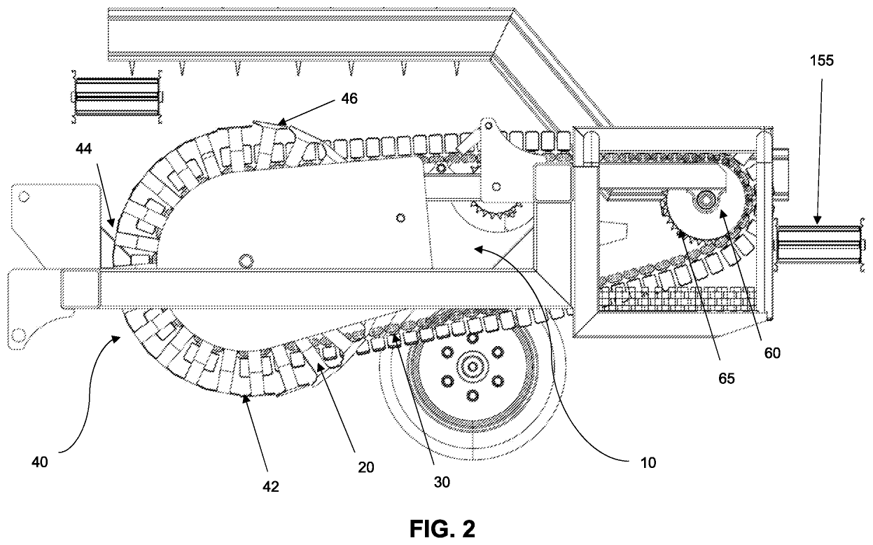

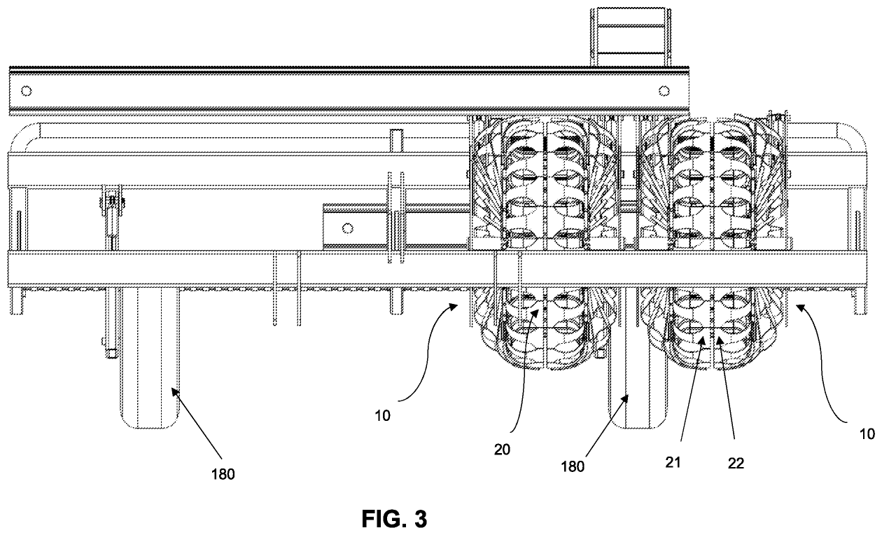

Referring to FIGS. 1 to 3, there is depicted a two row broccoli harvester 100, including two cutting units 10 attached to harvester frame. Harvester 100 is depicted in a two row configuration that is front mountable to a prime mover. It could alternatively be rear or side mountable. Alternatively, it could be configured in a three or four cutting unit configuration, due to the modular design of the frame and cutting units 10, as will be appreciated by the skilled addressee.

The harvester 100 includes two primary grading sections 120 (one of which is partially obscured in FIG. 1) and two grader standing areas 130, so that grading personnel can stand and grade the crop as it travels along the grading sections 120 of cutting unit belts 30 towards a secondary grading conveyer 150 with gripping cleats 155, and along the secondary grading conveyor 150. Crop passing grading inspection is able to be deposited on elevating conveyor 160 including raised cleats 165 to assist with elevation of the broccoli towards a delivery conveyor 170, so that it may then be further processed, etc.

The harvester 100 includes two land wheels 180, that may be adjusted upwards or downwards relative to the harvester frame 190, to alter the height of the frame relative to the ground

The cutting units 10 each comprise twenty four (24) cutting and carrying segments 20 that are adapted to cut the crop and lift the crop upwards. The segments 20 travel around a circular cutting unit circuit 40, and as they travel around the circuit 40 they move between a crop cutting and carrying position at a lower part of the circuit 42, a crop carrying and lifting position at an intermediate part of the circuit 44, and then a crop releasing position at an upper part of the circuit 46.

Each cutting segment 20 includes two cutting arms 21, 22, each arm having a cutter in a lower portion thereof.

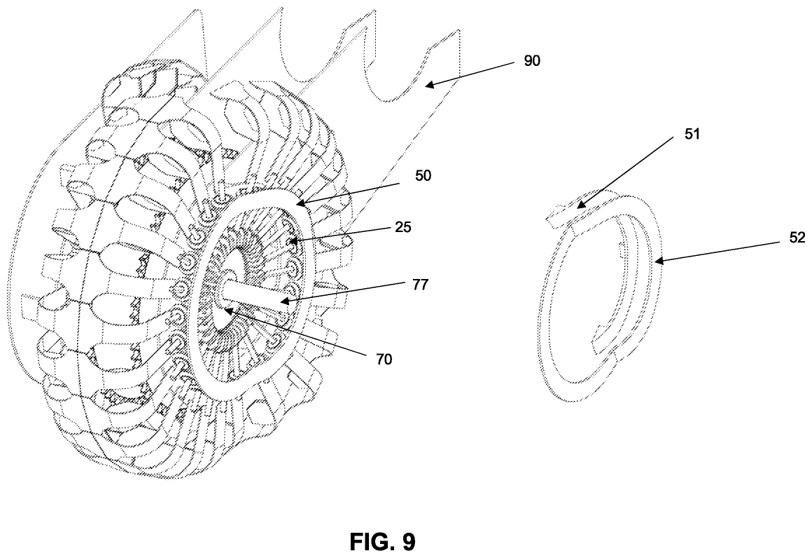

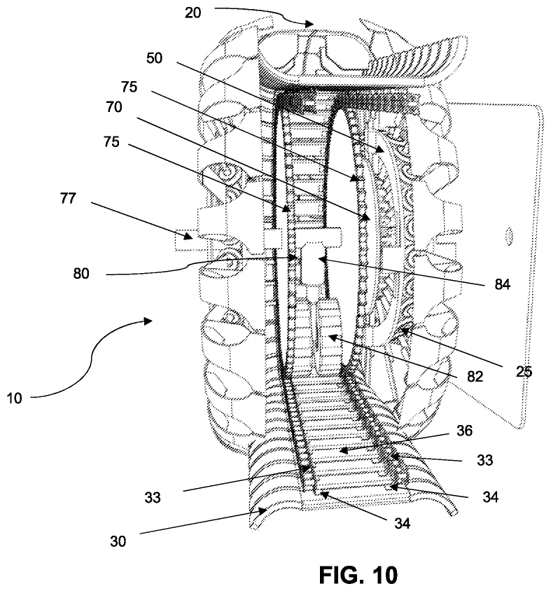

The harvester includes a driving mechanism for driving each of the cutting segments 20 around the cutting circuit, the driving mechanism for each set of cutting segments on each cutting unit 10 includes: a chained belt 30; a driving sprocket 65 on a driving roller 60; and a rear sprocket 75 on each rear roller 70. In use, the driving sprockets 65 drive the belts 20 around the rear sprockets 75 to turn each respective rear roller 70 and thereby move the segments 20 around the respective cutting unit circuit 40. The driving mechanism also includes a track (not shown in FIGS. 1 to 3) to guide the arms between the cutting, carrying, lifting and releasing position. The rear sprocket, and track is depicted more clearly in FIG. 10 (see items 75 and 50), and the track 50 more particularly in FIG. 9.

The harvester frame 190 supports the cutting units 10 above the ground and allows connection to a prime mover such as a tractor (not depicted in the drawings).

With reference to FIGS. 1 to 3, the harvester 100 may be substantially reduced in size and comprise a simplified configuration, for example, it may consist of small frame for attaching the cutting unit 10 to a prime mover (and it may be a single cutting unit, not two, or more, side-by-side), and many of the conveying components of that harvester 100 in FIGS. 1 to 3 may be dispensed with. In such a simplified configuration, the harvested crop can be taken from the grading sections 120 and placed into a bin by a worker walking alongside the cutting unit as it performs harvesting. Other harvesters incorporating the cutting unit may have different configurations, with more or less components and fall in between the proposed simplified configuration, and the configuration depicted in FIGS. 1 to 3.

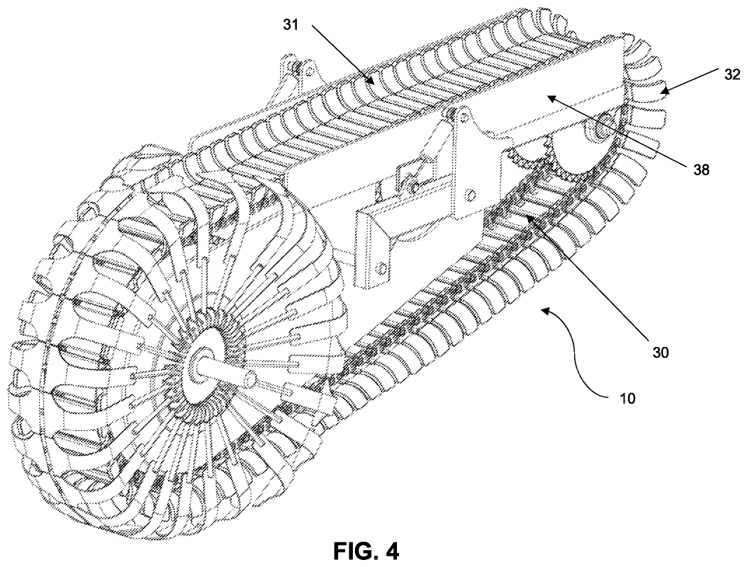

A more detailed account of the cutting units and the driving mechanism is provided with reference to FIGS. 4 to 8.

Turning now to FIGS. 4 to 8, there are depicted multiple views of parts of the harvester 100 of FIGS. 1 to 3, including parts of the cutting unit 10, part of the cutting unit frame 90, the chained belt 30 that loops around the rear roller 70 and the sprocket 65 of the driving roller 60. On FIG. 4, there is visible siding 38 that operates to hold in an upwards orientation the flexible portions 31, 32 of the belt during the conveying and grading sections of the belt 30.

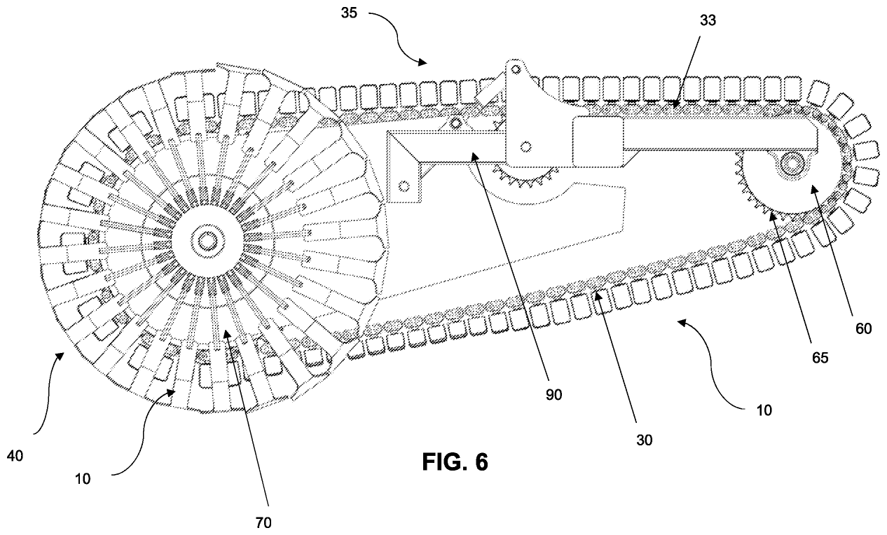

With reference to FIG. 6 in particular, there is shown a belt loop 35 which consists of the belt 30 looping around the rear roller 70, idler sprocket (suitably positioned to provide a flat upper part of the belt 30 for grading) and the driving roller 60, where the driving sprocket 65 on the driving roller 60 engages with the chains 33 connected to the belt 30, to cause the belt 30 to move around the belt loop 35 and thereby drive rotation of the rear roller 70.

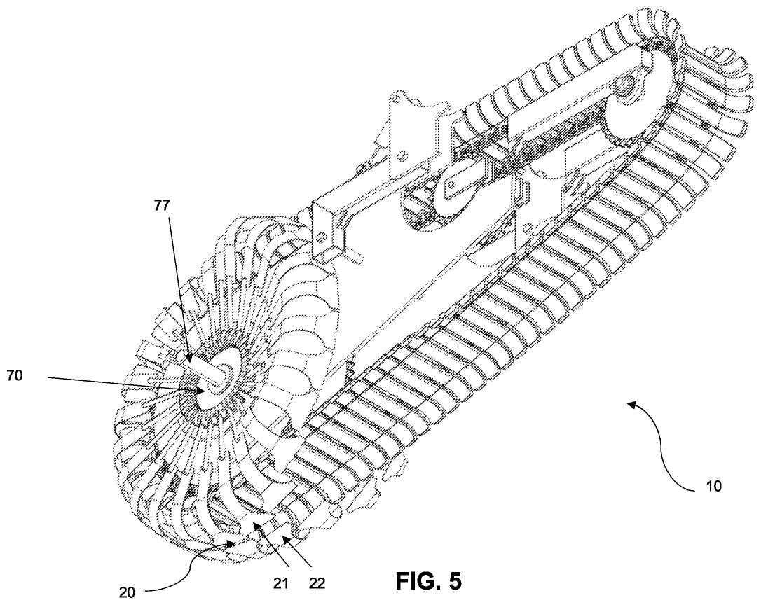

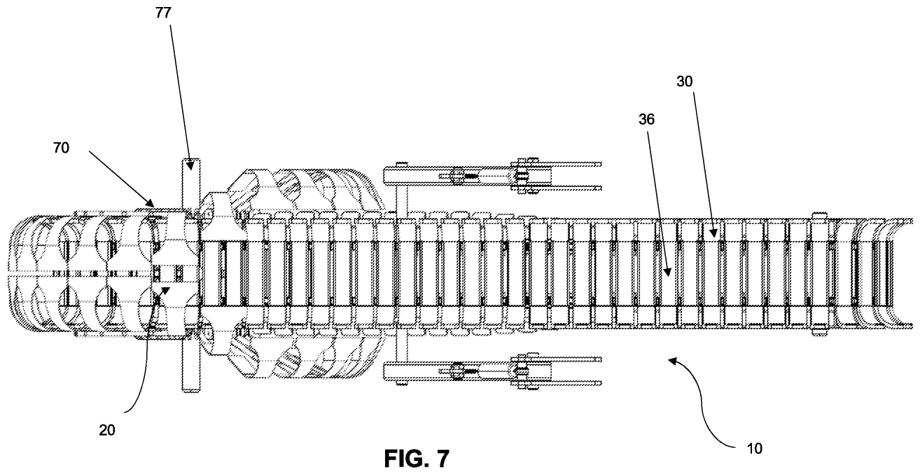

With reference to FIGS. 5 and 7 in particular, it will be appreciated that the segments 20 move towards a cutting position that is approximately underneath the axle 77 of the rear roller 70. Referring to FIG. 6, the segments 20 travel clockwise around the cutting unit circuit 40. The slats 36 that make up the belt 30 are also visible on FIG. 7.

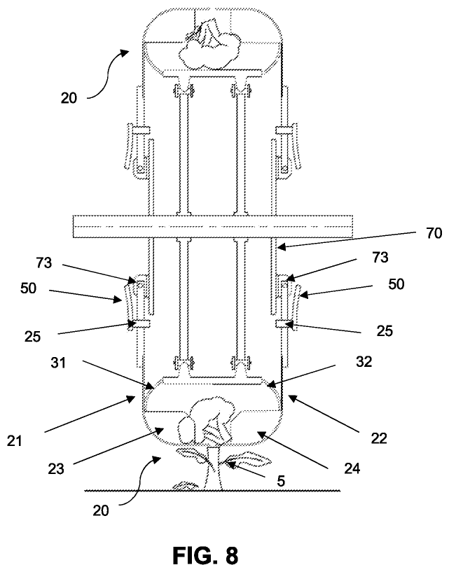

Referring to FIG. 8, at the lower part of the figure there is shown a cutting segment 20 in the cutting position, where the arms 21, 22 each include a paddle 23, 24 to aid in the carrying and/or lifting the harvested crop 5 as the arms rotate upward around the cutting unit circuit. The paddle portions are made of neoprene. Alternatively, the paddles may be made of other resilient materials such as soft rubber foam. The paddles 23, 24 are each fixed to a plate that is connected to each arm (not visible in FIG. 8). At the lower part of the figure there is shown a cutting segment 20 in the carrying position.

It may be seen that the flexible outer portions 31, 32 of the belt 30 are pushed inwardly by the arms 21, 22 in the cutting position. Part of the guide tracks 50 are also shown, as are pivot parts 73 on the rear roller 70, and arm rollers 25 on the arms 21, 22 that mechanically engage with track 50, which permits the arms 21, 22 to swing open and closed depending on their location around the cutting unit circuit.

With reference to FIGS. 8 and 9 the guide tracks 50 that enable the segments 20 to travel continuously around the cutting unit circuit during harvesting, and for the cutting segments 20 to provide substantially continuous cutting, carrying, lifting and releasing of the harvested crop, as the rear roller 70 rotates continuously about its axle 77. FIG. 9 also includes an outer portion of the track 52, and an inner portion 51 that, together with part of the frame 90 of the cutting unit, provides the guiding surface around which the arm rollers 25 travel to move the arms 21, 22 of cutting segments towards and away from each other to perform the cutting, carrying, lifting and releasing of the harvested crop.

FIG. 10 is a front sectional view of the rear roller 70, twin chained belt 30, cutting segments 20 and tracks 50, among other parts of the cutting unit 10. The parallel sprockets 75 of the rear roller 70 are shown to engage with parallel chain links 33 of belt 30 that are fixed to the slats 36 of the belt by take-off plates 34. As the chained belt 30, driven by the driving roller (not shown), travels around the belt loop (only part of which is shown in FIG. 10), it rotates the rear roller 70 around its axel 77. The rear roller 70, and thereby the segments 20, are able to be driven at a speed that substantially matches the speed of the land wheel (which is monitored via an encoder on the wheel measuring wheel revolutions), so that the cutting segments 20 travel together with the crop during cutting and deliver a passive cutting action.

FIG. 10 also depicts the crop portion cut adjuster 80 that is configured to ride on the upper surface of the crop (it does so indirectly, as it rolls on the central channel 35 of the belt 30 which directly rides on the upper surface of the belt 30). The crop portion cut adjuster 80 engages with the belt 30 via adjuster wheels 82 that rotate over the belt 30. Crop portion cut adjuster 80 further includes an extendable component 84 configured to raise and lower the adjuster wheels 82 with respect to the axel 77, to thereby adjust the distance between the belt 30 (and therefore upper surface of the row crop) and a cutting point for each segment 20. In this way, the proportion of the upper part of the crop that is cut by the cutting unit 10 may be adjusted.

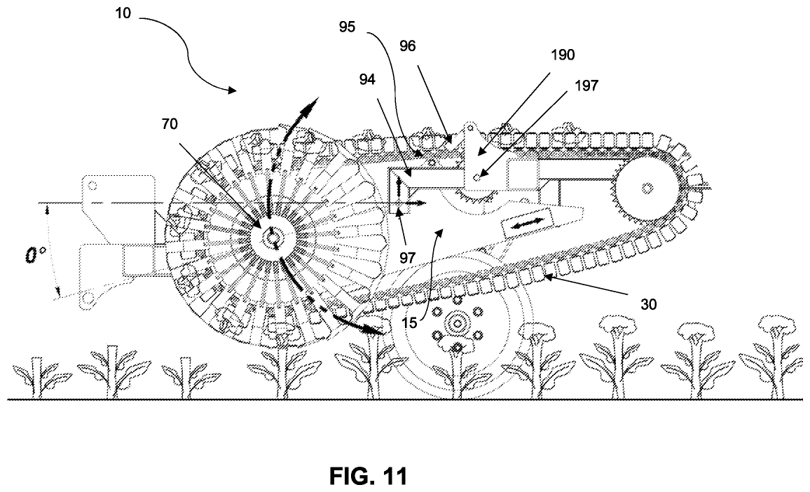

FIGS. 11 to 13 depict a cutting unit height controllable feature of the cutting unit 10.

The height of the cutting unit 10 is altered by a frame height controller 95, which is able to raise or lower the height of a rocking section 15 of the cutting unit 10 (relative to the harvester frame 190) and thereby enable raising or lowering of an effective lowest cutting height of the cutting unit 10. The frame height controller 95 includes an actuator 96 that is able to raise and lower the ride height arm 94 of the cutting unit 10 upwardly to raise the rocking section 15 of the cutting unit 10, and downwardly to lower the rocking part 15 of the cutting unit 10. The ride height arm 94 rotates relative to the harvester frame 190 about pivot point 195, and in that way frame height controller 15 controls the height of the rocking section 15 of the cutting unit 10.

The rocking section 15 of the cutting unit 10 is able to rock back and forward relative to the ride height arm 94 about a rocking pivot point 97. The rocking section 15 includes the rear roller 70 and the cutting segments, and these therefore rock back and forward depending on the height of the row crop. As described herein, the belt 30 is configured to ride along an upper surface of the row crop to be harvested

A very small force is required to rock the cutting unit backwards and forwards, an approximately 2 kg-force over about a 300 mm travel zone, in order to prevent or minimise any damage to the crop caused by belt 30 as it rides over the crop.

The frame height controller 95 operates automatically in response to the cutting unit 10 riding on the row crop and the rocking section 15 rocking back and forward relative to the ride height arm 94 depending on the height of the row crop. The ride height controller 95 automatically raises right height arm 94 (and thereby raises the rocking section 15 of the cutting unit 10) in response to the unit rocking forward (e.g. after a predetermined amount of forward rocking over a predetermined period of time of forward rocking). Likewise, the controller 95 automatically lowers right height arm 94 (and thereby lowers the rocking section 15 of the cutting unit 10) in response to the unit rocking backwards (e.g. after a predetermined amount of backwards rocking over a predetermined period of time of backwards rocking).

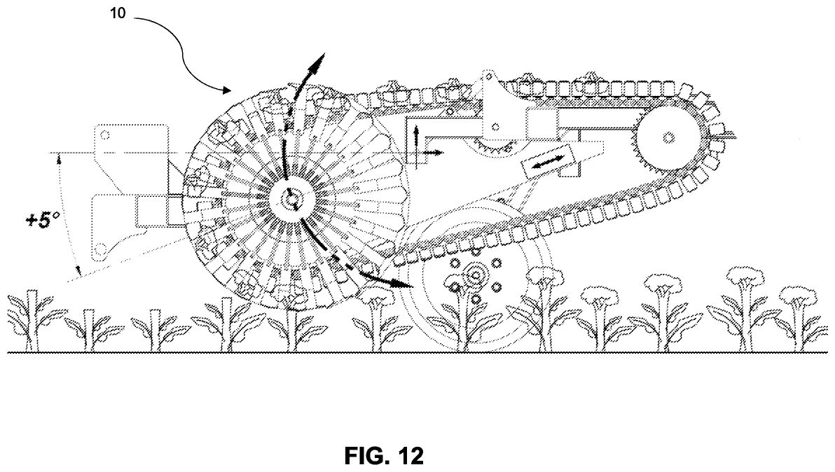

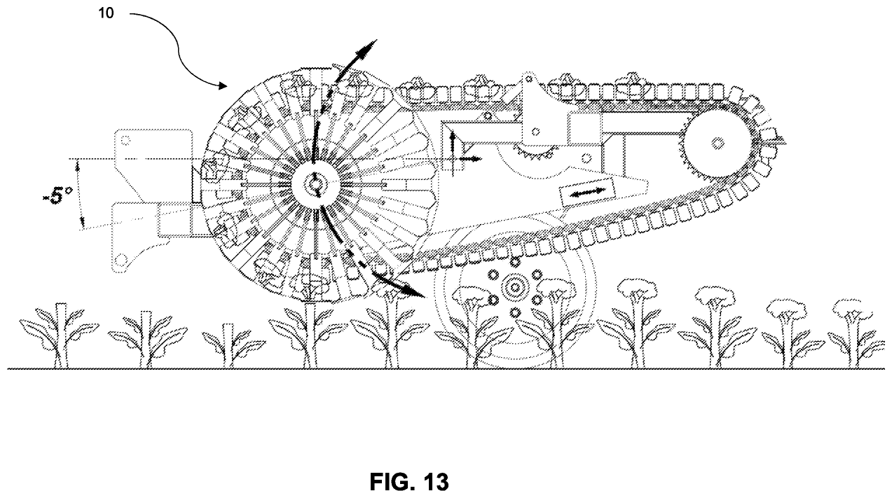

In FIG. 11, the unit is in a neutral position (e.g. to cut crop having an average height), whereas in FIG. 12, the unit is in a lowered position (e.g. to cut crop having a lower than average height), and in FIG. 13, the unit is in a raised position (e.g. to cut crop having a higher than average height).

It will be appreciated that the belt 30 as it rides over the crop heads, when used in conjunction with the rocking cutting unit, rocks back and forward over a number of crop heads of varying height and in doing so, provides a mechanism for maintaining the cutting at an ‘averaged’ height across a number of crop heads.

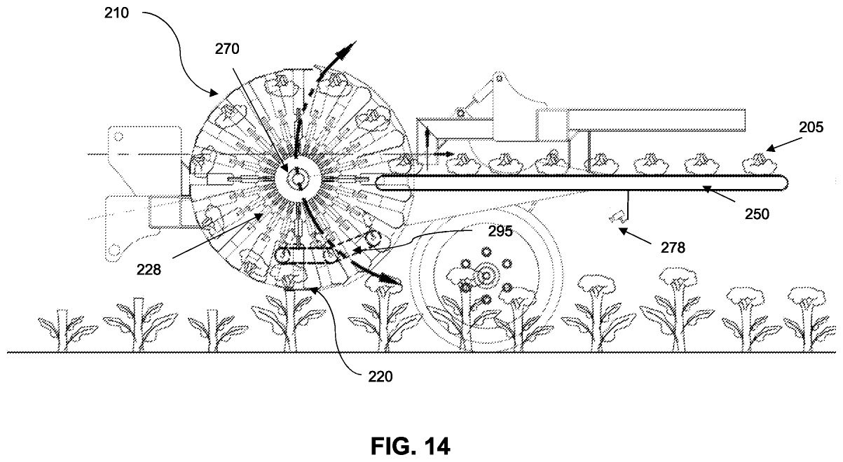

FIG. 14 depicts a cutting unit 210 according to a second preferred embodiment of the invention. The cutting unit 210 does not include a belt for driving the rear roller 270, rather the rear roller 270 is driven to rotate directly by an engine located within the roller 270 (the engine is not shown in FIG. 14). Further, the cutting segments 220 are not driven to the cutting and releasing position by a guide or by tracks, rather they are directly driven by actuators 228 on each arm, where the actuators are directly driven by individual drives that are automatically responsive to sensed information about the row crop. The sensed information is obtained by cameras 278 (only one of which is shown) that apply machine vision technology to sense crop information such as crop height and width, so as to permit selective harvesting.

Instead of a belt having multiple functions as was the case in FIGS. 1 to 13, the cutting unit of FIG. 14 delivers the harvested crop 205 to a conventional flat conveyer belt 250 for further processing. The cutting segments 220 in this configuration operate to cut, carry and lift the crop to the flat conveyor belt 250. The cutting unit 210 is a rocking unit, in the manner that was set out in relation to rocking cutting unit 10 described with reference to FIGS. 11 to 13.

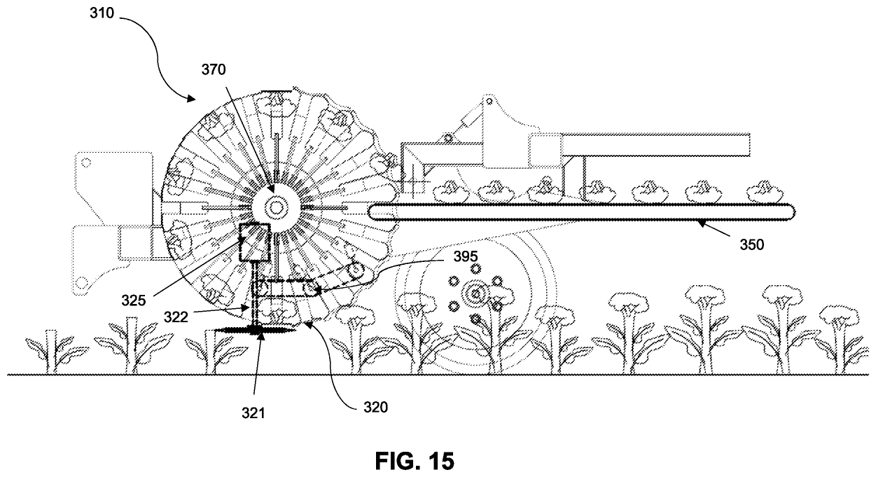

FIG. 15 illustrates a cutting unit 310 including carrying segments 320 that are adapted for guiding, carrying and lifting the crop, but not for cutting. Cutting of the crop is achieved by a rotary cutting blade 321, driven by a motor 325 located within the rear roller 370. The rotating drive shaft 322 is located in between the arms of the carrying segments 320 (the arms of each segment 320 need not come together around the lowest point of the circuit in this embodiment of the invention, as they are not performing any cutting action)

It is noted that the segments 320 of cutting unit 310 include arms with rounded ends that are not designed to cut, rather to guide or feed the crop towards rotary cutting blade 321.

FIGS. 14 and 15 include a small crop riding conveyor 295, 395 that is located in between

the arms of the cutting segments 220 and carrying segments 320. The small crop riding conveyor functions substantially the same as the crop riding belt described with reference for FIGS. 11 to 13.

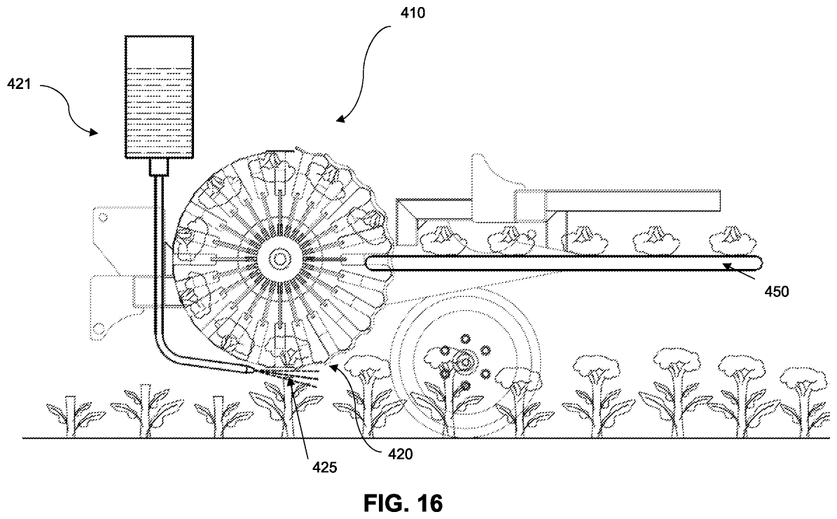

FIG. 16 illustrates a further alternative cutting unit 410 including carrying segments 420 that are adapted for guiding, carrying and lifting the crop, but not for cutting. Cutting of the crop is achieved by a waterjet cutter 421, where a high pressure jet of water 425 is used to cut the harvestable portion from the crop.

It is noted that the cutting unit 410 is fixed to the frame and not adapted for rocking.

As was the case for FIG. 14, the cutting units 310 and 410 of FIGS. 15 and 16 include a conventional flat conveyer belt 350, 450 for receiving harvest crop from the carrying segments 320, 420, for further processing of the harvested crop.

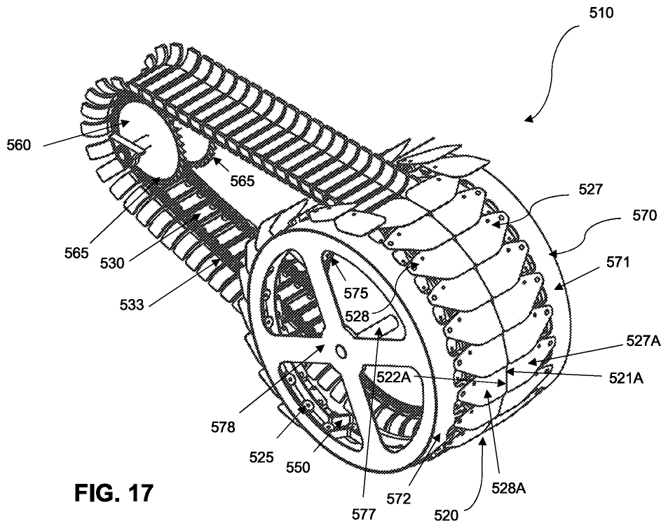

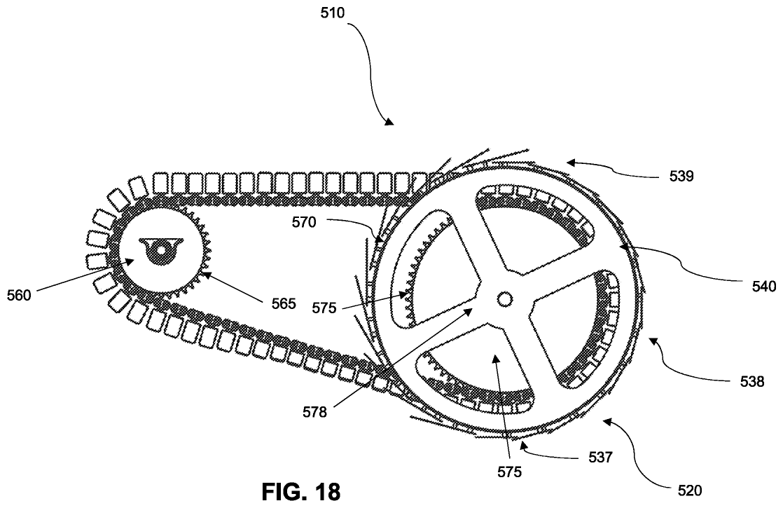

FIGS. 17 and 18 depict a cutting unit 510 including a series of cutting segments 520 that are adapted for cutting, carrying, lifting, and releasing the crop. The series of cutting segments 520 comprises two series of cutters 527, 528 on opposing sides of the rear drum roller 570. The individual cutters 527A, 528A of just one segment of the cutting unit 510 are labelled in FIG. 17; the other cutters in each of the series 527, 528 have the same configuration and properties as the identified cutters 527A, 528A, as described herein with reference to the FIGS. 17 to 19.

There are twenty four (24) segments in the series of cutting segments 520, and so there are forty eight (48) cutters in total.

Each of the cutters in the two series of cutters 527, 528 are pivotally connected to opposing rims 571, 572 of the rear drum roller 570. The driving roller 560 is adapted to drive the drum roller 570, via the twin chained belt 530, and thereby drive the series of cutting segments 520 around the circular cutting unit circuit 540 traced approximately by the rims of the drum roller 570. Each of the two chains links 533 of the chained belt 530 engage with respective driving sprockets 565 of the driving roller 560, and with respective rear roller sprockets 575 of the drum roller 570 (there are two rear roller sprockets, but only one is visible in the FIGS. 17 and 18). Driving of the series of cutting segments 520 is achieved by driving the roller 560 at a consistent speed, so that the cutting segments travel continuously in one direction around the cutting unit circuit 540.

The drum roller 570 rotates around the static hub 578 including four spokes and axel 577, around which the twin rear sprockets 575 of the roller 570 rotate.

The cutters 527A, 528A include rounded cutting edges 521A, 522A, and springs (not shown) which bias the cutters towards a closed position.

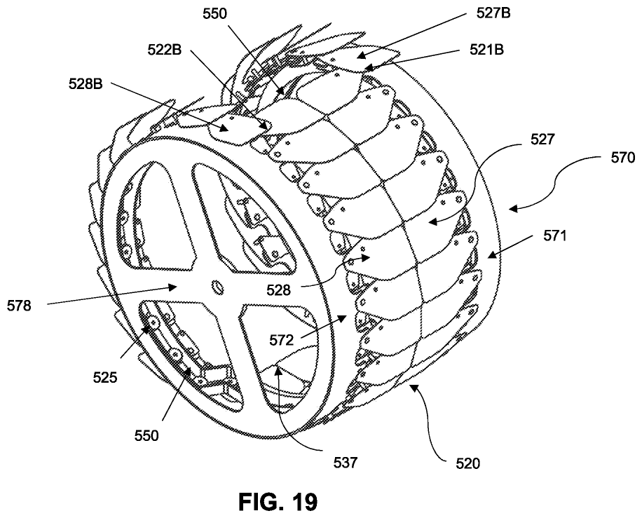

The cutters each have corresponding cutter rollers 525 (only one of which is labelled in FIG. 17) that, together with each respective cutter, travel around the cutting unit circuit 540. The cutter rollers 525 engage with static guide tracks 550 that are fixed to the static hub 578. As the cutter rollers 525 roll around the guide tracks 550, they guide the cutters, which are pivotally connected to the rear drum roller 570, between an open (release) and closed (cutting or carrying) position. There are two guide tracks 550, one on each side of the drum roller 570, see FIG. 19.

The cutting zone 537 of the cutting unit circuit 540 is located in a lower part of the cutting unit circuit, and in that zone the series of cutting segments 520 move to cut the crop (i.e. the series of cutters 527, 528 move together to cut the crop). The releasing zone 539 of the cutting unit circuit 540 is located in an upper part of the cutting unit circuit, and in that zone the cutters move away from each other to release the crop from the cutters (i.e. the series of cutters 527, 528 move apart to release the crop). In between the cutting and carrying zone 537 and the releasing zone 539 is a lifting zone 538, in which the series of cutters 527, 528 remain closed, and operate to raise the crop upwards.

The driving roller 560, operates to drive the rear drum roller 570 and thereby causes relative movement of the series of cutting segments 520, and in particular opening and closing of the series of cutters 527, 528 as they travel around the circuit 540. It will be appreciated that rolling of the drum roller 570 causes movement (e.g. pivotal movement) by the cutting segments as they interact with the guide track 550, and travel around the cutting unit circuit 540.

With reference to FIGS. 17 and 19, the rear roller 570 is configured in the form of a drum and a first series of cutters 527 are attached to a first rim 571 of the drum 570, and a second series of cutters 528 are attached to a second rim 572 of the drum 570, where the first rim 571 of the drum opposes the second rim 572 of the drum. The first rim 571 of the drum borders one of the guide tracks 550 for controlling movement of the first series of cutters 527, and the second rim 572 of the drum borders another guide track 550 for controlling movement of the second series of cutters 528. Each of the cutters in the first and second series of cutters 527, 528 is connected to respective cutter rollers 525 (only about seven of which are depicted in FIGS. 17 and 19) which travel within the respective guide tracks 550.

With reference to FIG. 19, the cutters 527B, 528B of one identified segment include rounded cutting edges 521B, 522B.

In the embodiment depicted in FIGS. 17 and 18, the series of cutters 527, 528 are moved between a non-cutting and a cutting position by a first (or primary) cutting control mechanism as well as a second (or secondary, or back-up) cutting control mechanism, to ensure cutting of the crop.

The first cutting control mechanism comprises a series of springs (not shown) where each cutter in each of the series of cutters 527, 528 has a corresponding spring attached to the rear drum roller 570 (i.e. 48 cutters, so 48 springs in total), to enable a fast cutting movement of the series of cutters 527, 528. As the series of cutting segments 520 travel around the cutting unit circuit 540, the cutter rollers 525 corresponding to each of the cutters (i.e. the 48 cutter rollers 525) move within guide tracks 550. At the cutting zone 537, the track is configured to allow release of the potential energy of the spring (i.e. contraction of the spring, which is biased to the closed position). Near the cutting zone 537, guide track 550 is depicted in FIGS. 17 and 19 to change course, and is directed inwardly and away (at almost right angles) from the preceding portion of the track 550 in an outer part of the static hub 578. The change in direction of the guide tracks 550 (each track is a mirror image of the other) permits the spring loaded cutters to move inwardly to the cutting position as the guide tracks 550 do not impede the contraction of the spring which operates to close the cutters. In cutting operation, due to contraction of the spring, the cutter roller 525 moves away from an outer wall of the guide track 550 and is able to freely move in the space between the inner and outer walls of the guide track 550. Although not depicted, the guide tracks 550 may be widened at this point to facilitate such unimpeded operation of spring to move the cutters to the closed position.

The second cutting control mechanism, which operates as a back-up to the first cutting control mechanism, comprises the guide tracks 550 which co-operate with the rollers 525 of the segments, to guide each of the cutters in each of the series of cutters 527, 528 to cut completion in the cutting zone 537, in case the fast cutting movement of the first cutting control mechanism (springs) does not complete cutting of the crop (e.g. due to the presence of crop leaf or a thicker crop stem). The outer walls of the tracks 550 act on the rollers 525 to force the cutters to cut completion. The cut completion position of the cutting segments 520, is the position where the two cutters have moved together to contact one another (e.g. when cutting edges of each of the two cutters are touching, as shown in the cutting zone 537 on FIG. 19).

It will be understood that the driving roller 560 to some extent controls or enables operation of the first and second cutting control mechanisms, and in particular closing of the series cutters 527, 528 in the cutting zone 537 (e.g. by rotating the drum roller 570 to which the cutters are attached, and when the cutters reach the cutting zone 537 they are released from a spring loaded position to close and cut, and then, as required, the cutters are forced into the closed position by the guide tracks 550).

In addition, the driving roller 560 controls opening movement of the series of cutting segments 520, and in particular opening of the series of cutters 527, 528 in a releasing zone 539 (working against the spring bias of each of the cutters) as they travel around their respective guide tracks 550 and as the corresponding cutter rollers 525 roll around those tracks 550. The channel bordered by the inner and outer walls of the guide tracks 550 moves outwardly towards the outer part of the static hub 578 near an upper part of the cutting unit circuit 540, and since the cutters are pivotally connected to the drum 570, they follow the tracks and pivot away from each other as shown in FIGS. 17 and 19 as they travel around that part of the circuit 540.

During harvesting, the driving roller 560 drives the series of segments 520 around the cutting unit circuit 540 at a speed that is substantially the same as the speed of the harvester relative to the row crop, between about 2 kilometres per hour and 5 kilometres per hour.

Regarding the configuration of the cutting unit 510 and series of cutters 527, 528 depicted in FIGS. 17 to 19, the inventor has observed in relation to broccoli that the cutters in operation push the leaves of the crop down and provide a consistent and clean cut (in part because of the reduced amount of leaf impeding the cutting by the cutting segments 520).

Although not depicted in FIGS. 17 to 19, the cutters 527A, 528A may include paddle portions to assist in the carrying and lifting of the crop by the cutters.

The benefits of the invention are manifold, and include one or more of the following:
A faster and therefore more efficient mechanised harvester;
A configuration of cutting components that provide for a clean and complete cut of the harvested crop;
A reliable and consistent mechanised solution, with operating components that can be readily replaced or repaired;
Means to avoid rising costs associated with labour intensive hand harvesting of row crops, and in particular brassicas;
Means to provide an adjustable cutting height during mechanised harvesting;
A cutting unit and harvester having reduced risk of mechanical breakdown or the need for servicing;
A unit that is able to continuously, and accurately, respond to the height of the row crop that is being cut;
A modular arrangement of unit that can cut different row configurations;
A fast moving mechanised harvester that is adapted to cut brassicas to a variety of different specifications, including both broccoli and cauliflower. In particular, the weighting of the rocking cutting unit may be modified and/or the cut height of the crop controlled by a crop portion cut adjuster, to deliver at cut that includes more or less leaf and/or stem;
A crop harvester and cutting unit that avoids or limits the need for static components that pass through the crop. Rather, the subject invention provides a cutting mechanism that travels together with the crop (at the same speed as the crop); and/or
An apparatus that minimises components near to and interacting with the crop during harvesting (i.e. the subject invention uses the cutters or cutting portions of the arms, which travel downwardly close to the cutting zone, and upwardly soon thereafter). This reduces problems impacting harvesters that force feed crop through the machine, as the leaves or other parts of the crop may tangle and rub against harvester parts, thereby impeding the flow of the crop past the machine and harvesting speed and reliability.

### GENERAL STATEMENTS

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that each unit between two particular units are also disclosed. For example, if 10 and 15 are disclosed, then 11, 12, 13, and 14 are also disclosed.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

The terms in the claims have the broadest scope of meaning they would have been given by a person of ordinary skill in the art as of the relevant date.

The terms “a” and “an” mean “one or more”, unless expressly specified otherwise

Neither the title nor any abstract of the present application should be taken as limiting in any way the scope of the claimed invention.

Where the preamble of a claim recites a purpose, benefit or possible use of the claimed invention, it does not limit the claimed invention to having only that purpose, benefit or possible use.

In the present specification, terms such as “part”, “component”, “means”, “section”, or “segment” may refer to singular or plural items and are terms intended to refer to a set of properties, functions or characteristics performed by one or more items having one or more parts. It is envisaged that where a “part”, “component”, “means”, “section”, “segment”, or similar term is described as consisting of a single item, then a functionally equivalent object consisting of multiple items is considered to fall within the scope of the term; and similarly, where a “part”, “component”, “means”, “section”, “segment”, or similar term is described as consisting of multiple items, a functionally equivalent object consisting of a single item is considered to fall within the scope of the term. The intended interpretation of such terms described in this paragraph should apply unless the contrary is expressly stated or the context requires otherwise.

The term “connected” or a similar term, should not be interpreted as being limitative to direct connections only. Thus, the scope of the expression an item A connected to an item B should not be limited to items or systems wherein an output of item A is directly connected to an input of item B. It means that there exists a path between an output of A and an input of B which may be a path including other items or means. “Connected”, or a similar term, may mean that two or more elements are either in direct physical or electrical contact, or that two or more elements are not in direct contact with each other yet still co-operate or interact with each other.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to agricultural industries, and in particular harvesters and components therefor.

1. A cutting unit for a harvester, the cutting unit having:
a series of cutting and carrying segments, each segment in the series being adapted to cause cutting of a crop and carrying of the crop;
a cutting unit circuit around which the series of segments travel; and
a driving mechanism to drive movement of the series of segments around the cutting unit circuit;
wherein the driving mechanism drives movement of the series of cutting and carrying segments around the cutting unit circuit to cut the crop, and to carry harvested crop, as the series of segments travels around the cutting unit circuit.

2. The cutting unit according to claim 1, wherein the driving mechanism drives the series of cutting and carrying segments continuously in one direction around the cutting unit circuit, and wherein the series of segments are adapted to lift the harvested crop around a part of the cutting unit circuit as the series of segments travel continuously in one direction around the cutting unit circuit.

3. (canceled)

4. The cutting unit according to claim 1 wherein the cutting unit is adapted to drive the series of segments at a consistent speed around the cutting unit circuit during harvesting.

5. The cutting unit according to claim 1, wherein adjacent segments in the series of segments are configured to provide substantially continuous, carrying, lifting and releasing of harvested crop.

6. The cutting unit according to claim 1, wherein:
each segment includes one or more cutters, each cutter comprising at least one cutting edge for cutting the crop,
the one or more cutters are adapted to lift and/or carry the harvested crop; and wherein each cutter includes a paddle portion for carrying and/or lifting the harvested crop, and
each segment includes at least two cutters which co-operate to cut and/or carry the crop.

7-9. (canceled)

10. The cutting unit according to claim 1, wherein each segment includes at least two opposing arms, and wherein the cutting unit is configured to cause relative opening and closing of the cutters or arms of each segment as it travels around the cutting unit circuit.

11. (canceled)

12. The cutting unit according to claim 1, wherein the driving mechanism is adapted to drive the series of segments so that they travel together with the crop within a cutting zone, and wherein the series of segments move to cut the crop in the cutting zone of the cutting unit circuit comprising a lower part of the cutting unit circuit, and the series of segments move to release the crop from the segments in a releasing zone of the cutting unit circuit comprising an upper part of the cutting unit circuit.

13. (canceled)

14. The cutting unit according to claim 1, wherein the cutting unit circuit is circular, or substantially circular

15. A cutting unit for a harvester, the cutting unit comprising:
a series of cutting and carrying segments, each segment in the series being adapted to cause cutting of a crop and carrying of the crop;
a cutting unit circuit around which the series of segments travel; and
a driving mechanism to drive movement of the series of segments around the cutting unit circuit;
wherein the driving mechanism drives movement of the series of cutting and carrying segments around the cutting unit circuit to cut the crop, and to carry harvested crop, as the series of segments travels around the cutting unit circuit;
wherein the cutting unit includes a cutting unit roller, the series of segments being connected thereto
wherein the driving mechanism includes a belt that travels around at least a part of the cutting unit circuit, and the belt, or part of the belt, forms a harvester conveyor; and
wherein a first side of the belt faces the crop during cutting, co-operates with the segments to carry and/or lift the harvested crop, and then receives and conveys the crop as it is released from the segments, and a second side of the belt faces the roller when the belt is travelling around the cutting unit circuit.

16. The cutting unit according to claim 15, wherein the series of segments are pivotally connected to the cutting unit roller; and wherein the driving mechanism includes a guide means to guide movement of the series of segments as they travel around the cutting unit circuit to cut, carry and release the crop; and wherein the guide means comprises a track that mechanically interacts with the series of segments, and wherein rolling of the cutting unit roller drives the series of segments around the track.

17-18. (canceled)

19. The cutting unit according to claim 15, wherein rolling of the cutting unit roller causes each of the series of segments to move between an open position and a closed position.

20-21. (canceled)

22. The cutting unit according to claim 15, wherein the belt travels around a driving roller and the cutting unit roller to cause rolling of the cutting unit roller; and wherein the belt includes one or more chain loops that couple with the driving roller and cutting unit roller.

23. (canceled)

24. The cutting unit according to claim 15, wherein the belt is configured to travel around a loop, the loop including at least a part of the cutting unit circuit, the loop further including one or more further harvesting sections.

25. The cutting unit according to claim 15, wherein each of the series of segments are moved between a non-cutting position and cutting position by a primary cutting control mechanism, and by secondary cutting control mechanism that ensures cutting of the crop.

26. A harvester for harvesting a brassica row crop, the harvester including:
a cutting unit having:
a series of cutting and carrying segments, each cutting segment in the series being adapted to cause cutting of the crop and carrying of the crop;
a cutting unit circuit around which the series of segments travel; and
a driving mechanism to drive movement of the series of segments continuously in one direction around the cutting unit circuit; and
a conveyor for conveying the harvested crop away from the cutting unit
wherein
the driving mechanism drives movement of the series of cutting and carrying segments around the cutting unit circuit to cut and carry the crop, and to release harvested crop to the conveyor, as the series of segments travel around the cutting unit circuit.
